(19) United States
(12) Patent Application Publication
(10) Pub. No.: US 2008/0085990 A1
(43) Pub. Date: Apr. 10, 2008

(54) Method for Producing Polyarylene Ether Ketones

(75) Inventors: Alexander Richter, Oer-Erkenschwick (DE); Bernd Gunzel, Haltern am See (DE); Christian Bierhaus, Dortmund (DE); Patrick Kreidler, Recklinghausen (DE); Stefan Nordhoff, Recklinghausen (DE); Michael Krenz, Marl (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/813,881

(22) PCT Filed: Nov. 18, 2005
(86) PCT No.: PCT/EP05/56060

§ 371 Date: Oct. 11, 2007

(30) Foreign Application Priority Data
Jan. 14, 2005 (DE) 10 2005 002 084.4

(51) Int. Cl. C08G 8/02

(52) U.S. Cl. 528/126

(57) ABSTRACT

A process for preparing a polyarylene ether ketone comprises the following process steps: a) reaction of an aromatic dihalogen compound with a bisphenol and/or a halophenol in the presence of alkali metal and/or alkaline earth metal carbonate or hydrogencarbonate in a high-boiling aprotic solvent to give a polyarylene ether ketone, b) wet comminution and simultaneous preextraction of the solidified reaction mixture, c) extraction and filtration of the wet-comminuted product in a pressure suction filter and d) drying of the extracted product. This combination enables improved workup of the reaction mixture.

The invention provides a process for preparing polyarylene ether ketones, in particular a process for working up the reaction mixture obtained from haloaromatics, phenols, carbonates and solvents, and isolation of pure polyarylene ether ketone (PAEK), for example polyether ether ketone (PEEK).

The preparation of PAEK by nucleophilic polycondensation of bisphenols and organic dihalogen compounds in a suitable solvent with use of alkali metal or alkaline earth metal carbonates is a known process which is described in a multitude of patent applications, for example in EP-A-0 001 879, EP-A-0 182 648 and EP-A-0 244 167. The performance of this process is always followed, after the end of the polycondensation, by a very complicated washing of the reactor effluent. The washing has the aim of removing the reaction solvent, inorganic salts, residual monomers and other compounds from the PAEK. In the course of the development studies on PAEK, it has been found that it is advantageous for the process and the product properties when the organic dihalides used are difluorine compounds. However, a disadvantage of the use of the difluorine compounds is the formation of sparingly soluble alkali metal or alkaline earth metal fluorides as by-products during the reaction. In addition, for the solution polycondensation, a suitable solvent has to be used in comparatively large amounts based on the overall reaction mixture in order to keep the polymer which forms in solution, even in the event of relatively high molar masses. For this use, the literature recommends diphenyl sulfone in the vast majority of cases.

Increased amounts of by-products or solvents in the polymer lead to various technical disadvantages in the end products, i.e. the moldings which are produced typically by injection molding or extrusion. They form streaks on the surface, and lead to odor nuisance, to bubble formation and to reduced mechanical properties of the materials. In addition, some by-products are potentially toxic and can lead to impairments in health. For these reasons, the volatile constituents are removed from polymers typically down to residual contents of less than 0.1%, in some cases even down to residual contents in the ppm range.

By their nature, the abovementioned by-products and diphenyl sulfone solvent present difficulties in the workup of the reaction product. All substances other than the polymer have to be removed from the PAEK by laborious washing in various solvents (EP-A-0 244 167, EP-A-0 182 648, EP-A-0 297 363, EP-A-0 322 151). These washings correspond additionally to a solid-liquid extraction, since the by-products and the solvent are disposed not only around but also within the solid polymer; depending on the temperature, particle size of the reactor effluent, type of solvent, etc. they require a large amount of time and large amounts of washing solvents. The polymers can also be washed with suitable solvents and elevated temperature and elevated pressure (WO 02/096974); under some circumstances, the product can, though, be unnecessarily damaged here in the event of excessively long treatment times and high temperatures. A further disadvantage of these processes is that very large amounts of wastewater and solvent which are laden with small amounts of metal halides, residual monomers and reaction solvents are generated, and can accordingly only be disposed of or worked up at great cost and inconvenience. On the other hand, the achievable purification is limited for an economic number of washing steps.

In addition to the process of polymer washing, further processes are known for removing inorganic salts or reaction solvents. Examples include the removal of inorganic salts by filtration before the solidification of the reaction mixture (U.S. Pat. No. 5,357,040, U.S. Pat. No. 5,288,834, EP-A-0 297 363), which, though, owing to the low viscosities required, necessitates large amounts of reaction solvent which subsequently has to be removed in a costly and inconvenient manner. The removal of the reaction solvent by spray drying (DE-A-43 01 543) or by degassing in an extruder is likewise known; however, neither process is useful for a full removal of the reaction solvent since the industrial realization is very costly and inconvenient for spray drying, especially in the presence of partly precipitated salts, and the required residence times for degassing in the extruder are so large at normal processing temperatures of from 350 to 420° C. that there is inevitably thermal damage to the PAEK.

The currently practiced industrial preparation process for PAEK comprises, by way of example, the following steps: polycondensation in solution, isolation of the reaction products from the reactor with cooling, optional comminution of the reactor effluent in a mill, repeated washing with acetone/ethanol/water and drying. However, the process steps mentioned, in addition to the difficulties mentioned above, ensure a high level of logistical complexity with regard to the different solvents and the movement of the material to mills, from there to wash vessels, further to driers, etc., which entails particular care in the handling of solids, for example for the avoidance of product losses (reduced yield) and contamination. Furthermore, there is the risk in these workup process steps which are separated from one another in apparatus and spatial terms that dangerous dust-air mixtures form from dry constituents of the reactor effluent and constitute an unnecessary explosion risk.

It is thus an object of this invention to avoid the abovementioned disadvantages and to discover an improved workup of the reaction mixture obtained in the PAEK preparation process.

This object is achieved by a process which comprises the following process steps:
a) reaction of an aromatic dihalogen compound with a bisphenol and/or a halophenol in the presence of alkali metal and/or alkaline earth metal carbonate or hydrogencarbonate in a high-boiling aprotic solvent to give a polyarylene ether ketone,
b) wet comminution and simultaneous preextraction of the solidified reaction mixture,
c) extraction and filtration of the wet-comminuted product in a pressure suction filter and
d) drying of the extracted product.

Examples of suitable aromatic dihalogen compounds are 4,4′-difluorobenzophenone, 4,4′-dichlorobenzophenone, 4,4′-dichlorodiphenyl sulfone, 4,4-difluorodiphenyl sulfone, 1,4-bis(4-fluorobenzoyl)benzene, 1,4-bis(4-chlorobenzoyl)benzene, 4-chloro-4′-fluorobenzophenone and 4,4′-bis(4-fluorobenzoyl)biphenyl. The halogen group is generally activated by a para-carbonyl or -sulfonyl group. In the case of a para-carbonyl group, the halogen is chlorine or preferably fluorine; in the case of a para-sulfonyl group, the halogen may be fluorine or chlorine, preference generally being given here to chlorine as the halogen owing to sufficient reactivity and lower costs. It is also possible to use mixtures of different dihalogen compounds.

Examples of suitable bisphenols are hydroquinone, 4,4′-dihydroxybenzophenone, 4,4′-dihydroxydiphenyl sulfone, 2,2′-bis(4-hydroxyphenyl)propane, 4,4′-dihydroxybiphenyl, bis(4-hydroxyphenyl) ether, bis(4-hydroxyphenyl) thioether, bis(4-hydroxynaphthyl) ether, 1,4-, 1,5- or 2,6-dihydroxynaphthalene, 1,4-bis(4-hydroxybenzoyl)benzene, 4,4′-bis(4-hydroxybenzoyl)biphenyl, 4,4′-bis(4-hydroxybenzoyl)diphenyl ether or 4,4-bis(4-hydroxybenzoyl)diphenyl thioether. It will be appreciated that it is also possible to use mixtures of different bisphenols.

Examples of suitable halophenols are 4-(4′-chlorobenzoyl)phenol and 4-(4′-fluorobenzoyl)phenol. With regard to the selection of the halogen, the same criteria apply as for the dihalogen compounds. It will be appreciated that it is also possible to use mixtures of different halophenols or mixtures of halophenols with a 1:1 mixture of aromatic dihalogen compound and bisphenol.

Suitable alkali metal and alkaline earth metal carbonates and hydrogencarbonates derive from lithium, sodium, potassium, rubidium, cesium, magnesium, calcium, strontium or barium. Typically, according to the prior art, a mixture of sodium carbonate and potassium carbonate is used.

According to the prior art, the high-boiling aprotic solvent is preferably a compound of the formula 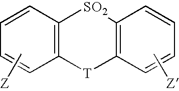
where T is a direct bond, an oxygen atom or two hydrogen atoms; Z and Z′ are each hydrogen or phenyl groups. It is preferably diphenyl sulfone.

The PAEK contains units of the formulae
(—Ar—X—) and (—Ar′—Y—)
where Ar and Ar′ are each a divalent aromatic radical, preferably 1,4-phenylene, 4,4′-biphenylene and 1,4-, 1,5- or 2,6-naphthylene. X is an electron-withdrawing group, preferably carbonyl or sulfonyl, while Y is another group such as O, S, CH₂, isopropylidene or the like. In these units, at least 50%, preferably at least 70% and more preferably at least 80% of the X groups should be a carbonyl group, while at least 50%, preferably at least 70% and more preferably at least 80% of the Y groups should consist of oxygen.

In the especially preferred embodiment, 100% of the X groups consist of carbonyl groups and 100% of the Y groups of oxygen. In this embodiment, the PAEK may, for example, be a polyether ether ketone (PEEK; formula I), a polyether ketone (PEK; formula II ), a polyether ketone ketone (PEKK; formula III) or a polyether ether ketone ketone (PEEKK; formula IV), but all other arrangements of the carbonyl and oxygen groups are of course also possible.

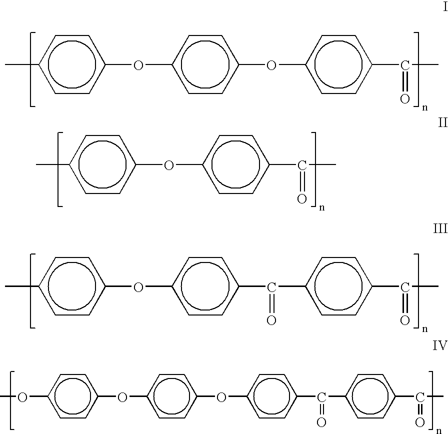

The PAEK is generally semicrystalline, which is expressed, for example, in the DSC analysis by discovery of a crystal melting point Tₘ which in most cases is of the order of magnitude of 300° C. or higher. However, the teaching of the invention is also applicable to amorphous PAEK. It is generally the case that sulfonyl groups, biphenylene groups, naphthylene groups or bulky Y groups, for example an isopropylidene group, reduce the crystallinity.

Owing to the existing reactivity of the functional groups and to the sparing solubility of the PAEK at relatively low temperatures, the reaction is typically carried out within the temperature range from approx. 200 to 400° C., preference being given to the range from approx. 250 to 350° C. Further details of the performance of the reaction can be taken from the abovementioned prior art.

After the reaction has been carried out, the reaction mixture is discharged from the reactor. It can then be solidified by all known methods. These include, for example, the quenching of the melt in a cold solvent, for example water, precipitation by addition of a further solvent which functions as a precipitant, or solidification on a cooled surface.

In the wet comminution which follows, the solidified reaction mixture, in a crusher, a mill or a dispersing unit, is taken up in an organic solvent, for example a ketone, an alcohol, an ether, an ester, an aromatic or in water, and subjected to strong shearing. For reasons of convenience, the weight ratio of the solvent to the solidified reaction mixture is in the range from about 1:10 to about 20:1, preferably in the range from about 1:1 to about 10:1 and more preferably in the range from about 2:1 to about 4:1. The crushers and mills used may be all those which are known to those skilled in the art; reference is made, for example, to Vauck/Müller, Grundoperationen chemischer Verfahrenstechnik [Basic Operations in Chemical Process Technology], 10th edition, chapter 5.1 (comminution), Deutscher Verlag für Grundstoffindustrie, Leipzig 1994. For example, it is possible to use jaw crushers, round crushers, roll crushers or impact crushers for a comminution to diameter from about 0.5 to 50 mm, or impact mills, roll mills, ball mills, vibratory mills, cutting mills or jet mills or dispersing units for a comminution to from about 50 to 500 μm.

In one possible embodiment, the wet comminution is carried out in a crusher in the presence of solvent (crusher/wash process).

In another possible embodiment, the wet comminution is carried out in a mill in the presence of solvent (mill/wash process). This procedure is recommended when the solidified reaction mixture is already in precomminuted form or is obtained directly in particulate form.

In a further possible embodiment, the solidified reaction mixture is initially precomminuted in a crusher in the presence or absence of solvent, after which the actual wet comminution is carried out in a mill (crusher/mill/wash process).

In the wet comminution, not only is a comminution of the reaction mixture achieved, but also a washing and preextraction. A portion of the salts obtained as a by-product and/or of the reaction solvent is removed at this early stage.

In a preferred variant, the mill/wash process is carried out with a dispersion unit with high shear force immersed in a stirred tank (which contains a suitable solvent and also the reactor effluent to be comminuted. For the latter, it is possible, for example, to use a device which is sold under the trade name DISPAX® or TURRAX® by IKA-Werke GmbH & Co. KG in D-79219 Staufen.

Suitable organic solvents for the wet comminution and for the subsequent extraction in the pressure suction filter are, for example, acetone, methyl ethyl ketone, methyl isobutyl ketone, methanol, ethanol, isopropanol, n- or i-butanol, 2-methoxy ethanol, 1,2-dimethoxyethane, tetrahydrofuran, ethyl acetate, benzene, toluene, xylene and also mixtures thereof. However, it is also possible in principle to use any other suitable solvent.

After the wet comminution, the suspension which forms is pumped into a pressure suction filter or discharged hydrostatically. The pressure suction filter consists of a vessel and also mobile or immobile, attached and/or installed components manufactured from a material of sufficient strength, so that pressures of at least 1 bar, preferably at least 6 bar and more preferably at least 25 bar can be controlled. The material has to have sufficient chemical resistance toward the feedstocks and by-products used, even at elevated operating temperature. The pressure suction filter consists preferably of metal, for example stainless steel (for instance 1.4571 stainless steel) or Hastelloy, and has inlets and outlets for liquids, suspensions and solids. At the bottom of the suction filter is mounted a filter element through which the solvent can flow away outward through the filtercake which builds up. Useful filter media include all of those which are suitable under the use conditions (temperature and medium) preference being given to metal filter elements. In addition, the pressure suction filter advantageously has a device for resuspending the solid, preferably a stirrer or a disperser. To clear away the solid, a device is advantageously installed immediately above the filter medium.

Designs of pressure suction filters are described, for example, in Vauck/Müller, Grundoperationen chemischer Verfahrenstechnik, 10th edition, chapter 4.1.3 (filtering and extractive pressing), Deutscher Verlag für Grundstoffindustrie, Leipzig 1994.

Depending on the particle size, the suspension from the wet comminution is filtered at a pressure of, for example, from 1 to 10 bar. Subsequently, the polymeric solid can be resuspended in the pressure filter at least once with an organic solvent, for example a ketone, an alcohol, an ether, an ester or an aromatic, and at least once with water without having to remove it beforehand. For resuspension, the installed stirrer is used. The wash ratio, i.e. the ratio of wash solvent to solid, may be varied from 1:100 up to 100:1. An economic optimum is achieved when a measurable depletion of the secondary components in the polymer is achieved with the wash solvent used.

After the resuspension, which can be carried out within the period from 1 min to several hours, the solid is allowed to settle and is filtered with a pressure of, for example, from 1 to 10 bar. The temperatures of the solvents are between ambient temperature and boiling temperature of the solvent used under the pressure used, preferably approximately at boiling temperature.

Subsequently, the filtercake can be dried in the pressure suction filter by air or an inert gas or steam. Alternatively, the solid may also be dried in any drying apparatus known to those skilled in the art. Examples include convection driers (for example paddle driers) and contact driers (for example rotary tube driers).

The process according to the invention may be combined advantageously with one or more further process steps which are illustrated below:
a) Removal of the reaction solvent from the reaction mixture in an extruder connected downstream of the reactor under reduced pressure and subsequent cooling and comminution of the extrudate in water. This removes at least 2%, at least 5%, at least 10%, at least 20%, at least 30%, at least 40%, at least 50% or at least 60% of the reaction solvent. Typically, operation is effected at a material temperature of from 250 to 400° C., preferably from 300 to 390° C., and at a pressure of from 0.1 to 950 mbar, preferably from 50 to 500 mbar. Owing to the high boiling point, only a partial removal of the reaction solvent is viable here. The partial removal of the reaction solvent by means of an extruder does, though, have the advantage that less wash solvent is required overall in the later washing operation. The subsequent wash/mill process which follows next is also simpler because a reduced amount of reaction mixture is used and because it is already present in precomminuted form, for instance as granule.
b) Discharge of the reactor contents through a nozzle with the aid of an extruder or of a gear pump and cooling and comminution of the resulting extrudate in water or a suitable other solvent, for example an alcohol, for instance ethanol. Here too, the subsequent wash/mill process is simpler because the reaction mixture is already in precomminuted form, for instance as granule.
c) Removal of inorganic salts from the liquid reaction mixture by filtration or centrifugation. This can be done either by removing the salts by filtration or centrifugation of the bottom effluent from the reactor or by continuous removal of the salts from a circulation stream around the reactor during or after the polycondensation.

The salts here are both the halides formed in the reaction, for example sodium, fluoride and potassium fluoride, and any excess of base used, for example sodium carbonate. The temperature is preferably above the solidification temperature of the polymer but below the boiling temperature of the reaction solvent at the prevailing pressure. In the filtration of the bottom effluent, an optimum has to be found in a manner known to those skilled in the art between the low viscosity at high temperatures and the simpler structure of filters for solid-liquid separation tasks at low temperatures.
In this way, the multistage and thus complicated washing of the reaction mixture with water to remove the salts is either avoided entirely or at least distinctly simplified owing to the already reduced salt burden.
d) Spray-dispensing of the reactor contents to obtain particles or prills. Here, particulate reaction mixture is prepared by spraying the liquid reaction mixture through a nozzle into a cooled vessel. This forms particles whose size and shape can be influenced by the selection of the process parameters. Thus, an already particulate mixture which advantageously already has a large surface area is supplied to the mill/wash process.
e) Spray-drying of the mixture obtained in the reactor to obtain particles with uniform, at least partial removal of the reaction solvent and any further volatile constituents present by evaporation. In this process, the reaction mixture is forced through a suitable nozzle at an elevated temperature. This forms particles whose size and shape can be influenced by the selection of the process parameters and thus adapted to the further processing. Here too, an already particulate mixture which advantageously already has a large surface area is supplied to the mill/wash process.
f) Solidification of the reactor contents using a cooled, moving metal belt. Here, the reaction mixture, after being discharged from the reactor, is solidified on a cooled, moving metal belt (for example steel belt) in the form of pastilles, flakes, extrudates or films. The belt rotates about two rollers and is cooled from below by a suitable cooling medium. It is possible to realize different temperature zones. If appropriate, a temperature of only slightly below the reaction temperature may be established in a first cooling zone, which is followed by further cooling over several temperature stages to from 20 to 120° C. and preferably to from 40 to 100° C. The process proceeds continuously. In principle, the melt leaving the reactor may be applied to the belt with the aid of distribution devices in the form of films, extrudates, flakes or pastilles. In this case, the material is advantageously already preshaped in a defined manner to a very great extent and can be supplied to the mill/wash process as a dust-free material.
g) Direct introduction of the liquid reactor contents into a water bath for solidification. In this case, the melt is metered into water which generally has a temperature in the range from 20 to 100° C. The quenching gives rise to internal stresses in the solidified reaction mixture which advantageously cause easier grinding in the mill/wash process.
h) Removal of the salts from the liquid reaction mixture by liquid/liquid extraction. A suitable process is described in EP-A-0 292 211 which is incorporated here explicitly by reference.

In a particularly advantageous manner, one of steps a), d) and e) is combined with one of steps c) and h), so that there is an initial removal of the salts. In particular, this counteracts blockage of the nozzle in the spray-dispensing step of d) or e).

As a result of the use of an apparatus for a combined crusher/wash process, mill/wash process or crusher/mill/wash process which is upstream of the pressure suction filter, the reactor effluent is advantageously ground in a solvent; this eliminates the risk of a dust explosion and distinctly reduces the volume of material for the wash in the pressure suction filter which follows. This distinctly reduces the complexity of equipment required.

Use of the pressure suction filter allows all washing and in principle also the drying steps to be carried out in one vessel. The possibility of washing with the different solvents under elevated temperature and elevated pressure guarantees reduced washing times and/or better washing action.

The washed and/or dried product is generally in the form of microporous particles. It can be used directly in this form, for example as coating material, but it may also be granulated and, if desired, processed to compounds by addition of further substances such as fillers, pigments, stabilizers, other polymers, processing assistants and the like. Suitable compounds, their production and use are known to those skilled in the art.

1. A process for preparing a polyarylene ether ketone comprising:
a) reacting an aromatic dihalogen compound with a bisphenol and/or a halophenol in the presence of alkali metal and/or alkaline earth metal carbonate or hydrogencarbonate in a high-boiling aprotic solvent to give a polyarylene ether ketone,
b) wet comminuting and simultaneous preextracting of the solidified reaction mixture of step a),
c) extracting and filtrating the wet-comminuted product of step b) in a pressure suction filter and
d) drying the extracted product of step c).

2. The process as claimed in claim 1,
wherein
the polyarylene ether ketone is a PEEK, a PEK, a PEKK or a PEEKK.

3. The process as claimed in claim 1,
wherein
the wet comminution is carried out in a crusher, in a mill or by means of a dispersing unit.

4. The process as claimed in claim 1,
wherein
extraction is effected repeatedly in the pressure suction filter to resuspend the wet-comminuted product each time.
